(19) United States
(12) Patent Application Publication
(10) Pub. No.: US 2014/0180708 A1
(43) Pub. Date: Jun. 26, 2014

(54) SYSTEMS AND METHODS FOR RESPONDING TO REQUESTS FOR HEALTH RELATED INFORMATION

(71) Applicant: The Corporation of Mercer University, Macon, GA (US)

(72) Inventor: Ashish Arjun Advani, Atlanta, GA (US)

(73) Assignee: The Corporation of Mercer University, Macon, GA (US)

(21) Appl. No.: 14/135,037

(22) Filed: Dec. 19, 2013

Related U.S. Application Data
(60) Provisional application No. 61/745,714, filed on Dec. 24, 2012.

(51) Int. Cl. G06F 19/00

(52) U.S. Cl. CPC G06F 19/326
USPC 705/2

(57) ABSTRACT

Embodiments provide for health related inquires, such as inquiries for information about a drug, disease, or other condition, to be received and responses to the inquiries to be delivered to the requester. The inquiries may be submitted electronically and the response may likewise be returned electronically. It may be determined whether the requester is a healthcare provider or a patient and the formulation of the response proceeds based on which type of requester submitted the inquiry. Delivery characteristics may be specified for the inquiry such as the delivery type and a timeframe for delivery. An account may be provided for requesters to provide information including a default delivery type and credentials to establish the requester type. Additional features may be provided including newsfeed subscriptions related to the inquiry to provide ongoing information subsequent to the submission of the inquiry.

### TECHNICAL FIELD

Embodiments are related to information systems. More particularly, embodiments are related to systems and methods for responding to requests for health related information.

### BACKGROUND

Access to health related information is important for healthcare providers as well as their patients. Healthcare providers prescribe medications for medical conditions that have been diagnosed. Therefore, healthcare providers must have an understanding of the risks, benefits, and other information of a particular drug including intended effects, side effects, dosages, interactions with other medications and the like. While information that is provided by the drug manufacturer and other resources is available to the healthcare provider, accessing the information directly may require research and other time consuming efforts. Furthermore, the healthcare provider wants to be sure that any information discovered is as credible and unbiased as possible. This presents a burden to the healthcare provider.

Efforts have been made to provide less burdensome access to health related information for healthcare providers. For instance, pharmacy institutions may provide a health information service. Typically, a healthcare provider makes a phone call to a health information center of the pharmacy institution and presents a question about a particular medication or other healthcare related topic such as disease or condition information. For every phone call by a given healthcare provider, that provider must provide the same identification and contact information in order to present the current question, and this repetition of information eventually becomes an annoyance to the caller. Pharmacy students then research the medication and draft a response which is peer reviewed. The response may then be provided to the healthcare provider via a phone call or an email. While this does relieve some of the burden on the healthcare provider, the healthcare provider must make the effort to find contact information for the health information center and then make the call. Furthermore, the healthcare provider has no way to monitor the process of receiving a response and has no way to receive future information related to the question unless submitting a future request.

Similarly, patients may seek information about medications that the patients have been prescribed or medications that the patients are already taking or are planning to take. Patients may also have access to publicly available health related information but may be unaware of or otherwise unable to find the desired information. As the services of health information centers of pharmacy institutions are only available to healthcare providers, patients must rely on speaking with a healthcare provider or a pharmacist, where both of these professionals are generally not in a position to spend the time necessary to provide detailed information that a patient may be seeking

### SUMMARY

Embodiments address issues such as these and others by providing systems and methods that provide access to health related information such as drug information. The systems and methods provide requesters such as a healthcare provider or a patient with a user interface to submit a health related inquiry. The submission may specify a delivery characteristic for the expected response, such as a type of delivery and/or a timeframe for delivery. A response to the inquiry is formulated, and the process of formulating the response may depend upon whether the requester is a healthcare provider or a patient. The response may be a customized response, particularly for a healthcare provider, where the customized response is drafted by another individual. Furthermore, the response may be generated as a result of an automated search, particularly for patients. Other features may also be included, such as a progress indicator and account based features such as credential and preference storage and newsfeed subscriptions.

Embodiments provide a method of providing health related information that involves receiving an electronic inquiry for health related information and receiving an entry of an electronic response delivery characteristic. The method further involves formulating a customized electronic response to the electronic inquiry, the customized electronic response providing the health related information. Additionally, the method involves providing the customized electronic response to the electronic inquiry in accordance with the electronic response delivery characteristic.

Embodiments provide a method of providing health related information that involves receiving an electronic inquiry for health related information and determining from the inquiry whether a requester is a healthcare provider or a patient. The method further involves formulating an electronic response to the electronic inquiry with the health information of the electronic response being based on whether the requester is a healthcare provider or a patient. Additionally, the method involves providing the electronic response to the electronic inquiry.

Embodiments provide a computer system that includes a network interface and a processor in communication with the network interface. The processor is configured to receive an electronic inquiry for health related information and receive an entry of an electronic response delivery characteristic, and the processor is further configured to determine from the inquiry whether a requester is a healthcare provider or a patient. The processor is also configured to access an electronic response to the electronic inquiry with the health information of the electronic response being based on whether the requester is a healthcare provider or a patient. Additionally, the processor is configured to provide the electronic response to the electronic inquiry in accordance with the electronic response delivery characteristic

### DESCRIPTION OF THE DRAWINGS

FIG. 1 shows an example of a first process of providing health related information to a requester such as a healthcare provider.

FIG. 2 shows an example of a second process of providing health related information to a requester such as a patient.

FIG. 3 shows an example of a system that provides health related information and that includes one or more computers of a health information center linked via a network to electronic devices of requesters.

FIGS. 4A-4C show an example of a set of logical operations performed by one or more computers of the health information center to provide health related information.

FIG. 5 is an example of a screen capture providing an interface for a requester to create an account and set preferences and credentials with the system that provides health related information.

FIG. 6 is an example of a screen capture providing an interface for a requester to submit an inquiry to the system for providing health related information.

FIG. 7 is an example of a screen capture providing an interface for a requester such as a healthcare provider to view progress of the system that providing health related information.

FIG. 8 is an example of a screen capture providing an interface for a requester such as a patient to access a response to the inquiry.

FIGS. 9A and 9B show an example of a formulated response to an inquiry from a requester such as a healthcare provider that may be delivered electronically.

FIG. 10 shows an example of a formulated response to an inquiry from a requester such as a patient that may be delivered electronically.

FIG. 11 shows an example of a screen capture providing a newsfeed notification related to a health information inquiry.

FIG. 12 shows an example of a networking effect resulting from the establishment of an online community of requesters and responders.

FIG. 13 shows an example of a display showing communication threads of a particular forum provided via the online community of requesters and responders.

### DETAILED DESCRIPTION

Embodiments provide systems and methods that receive health related inquiries from one or more types of requesters and provide one or more types of formulated responses in accordance with one or more delivery characteristics. In some embodiments, the type of the formulated response may vary depending upon the type of requester. In some embodiments the delivery characteristic(s) may be specified, such as a preference within an account of the requester and/or via the submission of the inquiry.

The following discussion is stated with respect to drug related information. However, it will be appreciated that these systems, methods, and devices are also equally applicable for other health related information including disease and condition information. Therefore, the following discussion should be considered to also include the provisioning of all types of health related information.

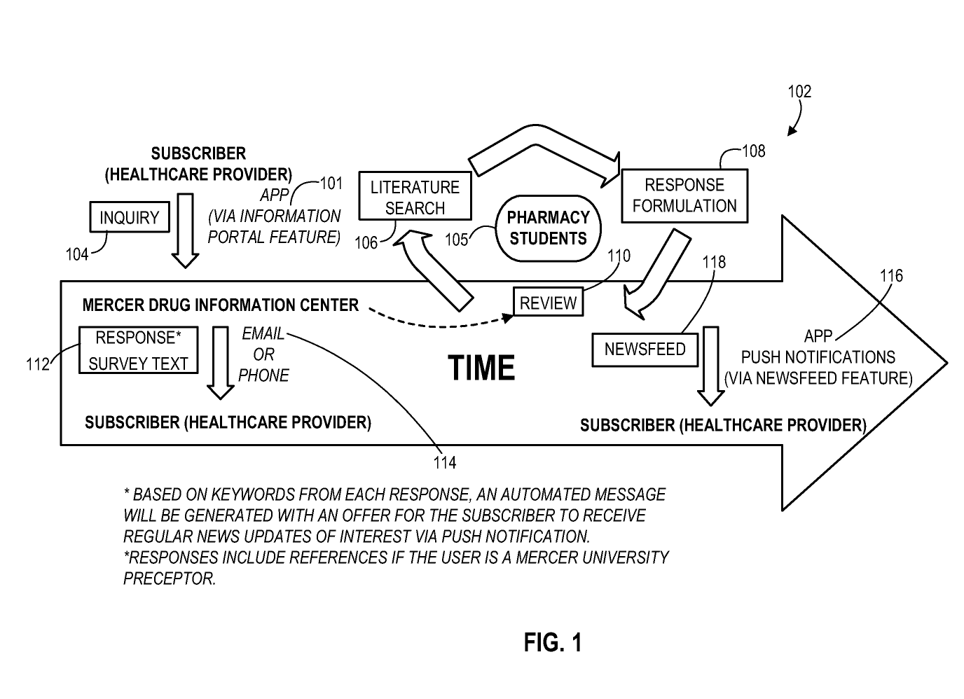

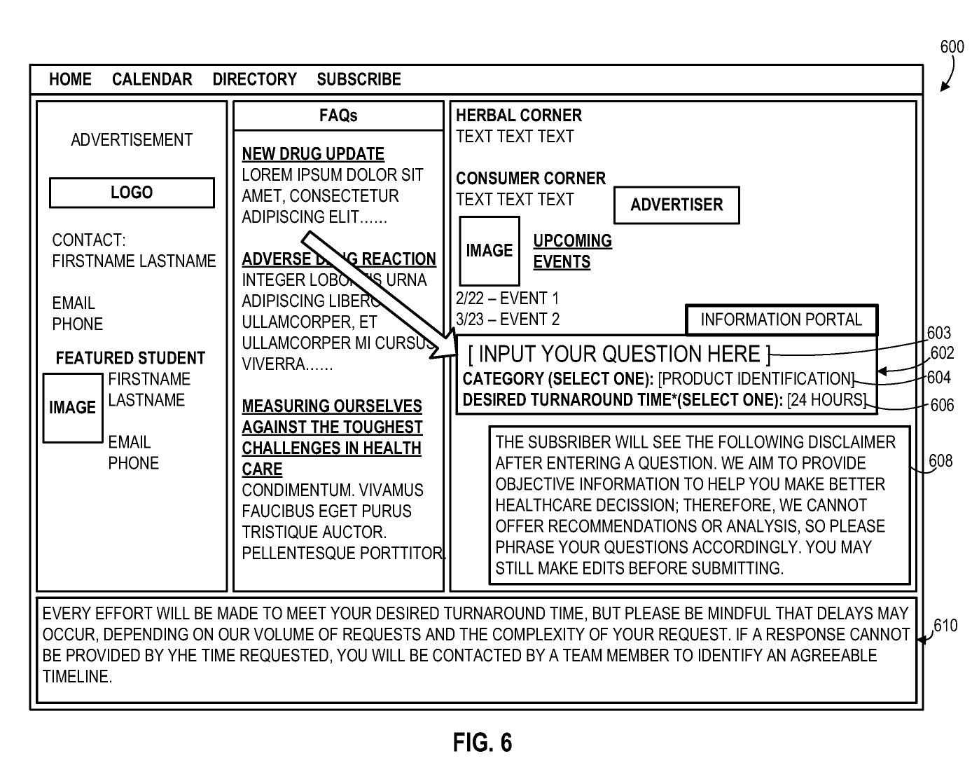

FIG. 1 shows an example of a process 102 for receiving a drug related electronic inquiry 104 from a requester such as a healthcare provider as well as formulating and delivering a response 112. In this particular example, the requester utilizes an application program 101 that provides an information portal or accesses a web based information portal. The information portal provides a user interface for submitting the electronic inquiry 104. The user interface is discussed in more detail below with reference to FIG. 6.

The inquiry 104 requests information about a particular drug, and the inquiry 104 is then handled based on various factors. For instance, in this example of the process 102, the response 112 is intended to be customized and provide information suitable for a healthcare provider. Therefore, the inquiry 104 is received by a server computer but is ultimately channeled to a human researcher such as a pharmacy student 105 who may be attending a pharmacy institution that provides a health information center that implements the process 102. The researcher performs a literature search 106. In some implementations, the literature search 106 is based on exclusively on published medical literature from peer reviewed journals and relevant prescribing information from the Food and Drug Administration (FDA) approved package insert for the drug. Other implementations may capture a broader set of information, such as by researching within all available drug publications from authors including the drug manufacturer, government institutions including the FDA and others, private entities other than the drug manufacturer such as physician associations, pharmacy associations, and so forth.

After the literature search 106, the researcher then begins a response formulation process 108. Here, a custom response is drafted that typically includes citations to the various items of literature that were previously discovered. The drafted response is then passed on for a review process 110 where peers review the draft to ensure accuracy and completeness. If necessary, the inquiry may be subjected to additional literature searching 106 and/or response formulation 108, followed by additional review 110. Upon the custom formulated response being approved by the review 110, the finalized response 112 is then accessed by the server and delivered to the requester.

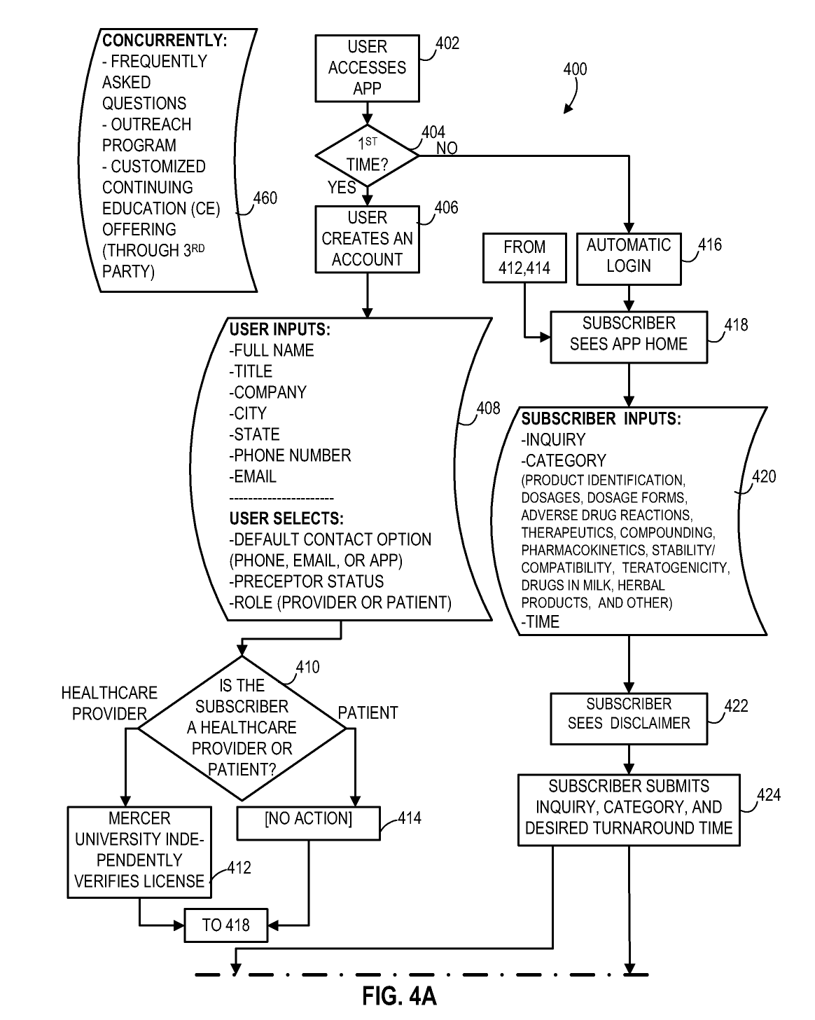

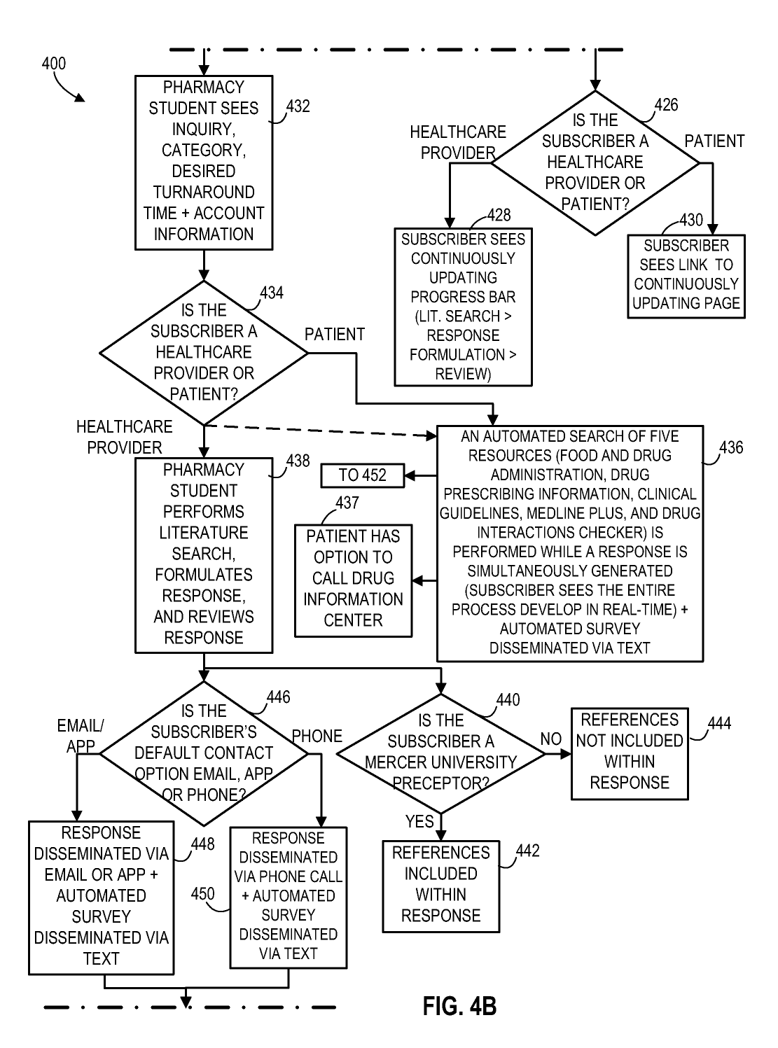

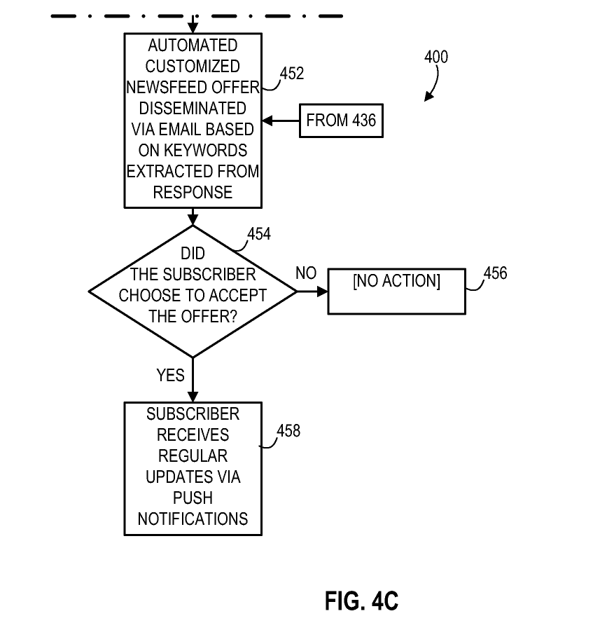

The delivery of the formulated response may also be subject to various factors. For instance, the process 102 may allow for the requester to specify one or more delivery characteristics. Delivery characteristics may include a type of delivery 114, such as an email, a phone call, or other form of electronic communication. Delivery characteristics may also include a time frame for delivery, where options may range from as soon as possible to within 24 hours, to within a week, to any point in the future for inquiries lacking any urgency. Manners of specifying such delivery characteristics are discussed in more detail below with reference to FIGS. 4-6.

The process 102 may also provide for ongoing updates regarding the subject matter of the inquiry 104 via newsfeeds 118 and notifications 116. The requester may be given an option, either at the time of receiving the response and/or at the time of establishing an account with the health information center, of subscribing to newsfeeds 118. The newsfeeds 118 may be based on keywords and/or categories found within the response and/or from the inquiry. In this manner, the requester may receive current information relevant to the initial inquiry without subsequent inquiry submissions. For instance, the newsfeeds may include a feed that provides information from resources including the National Library of Medicine DIRLINE, Medline Plus, FDA, and the Institute for Safe Medication Practices (ISMP).

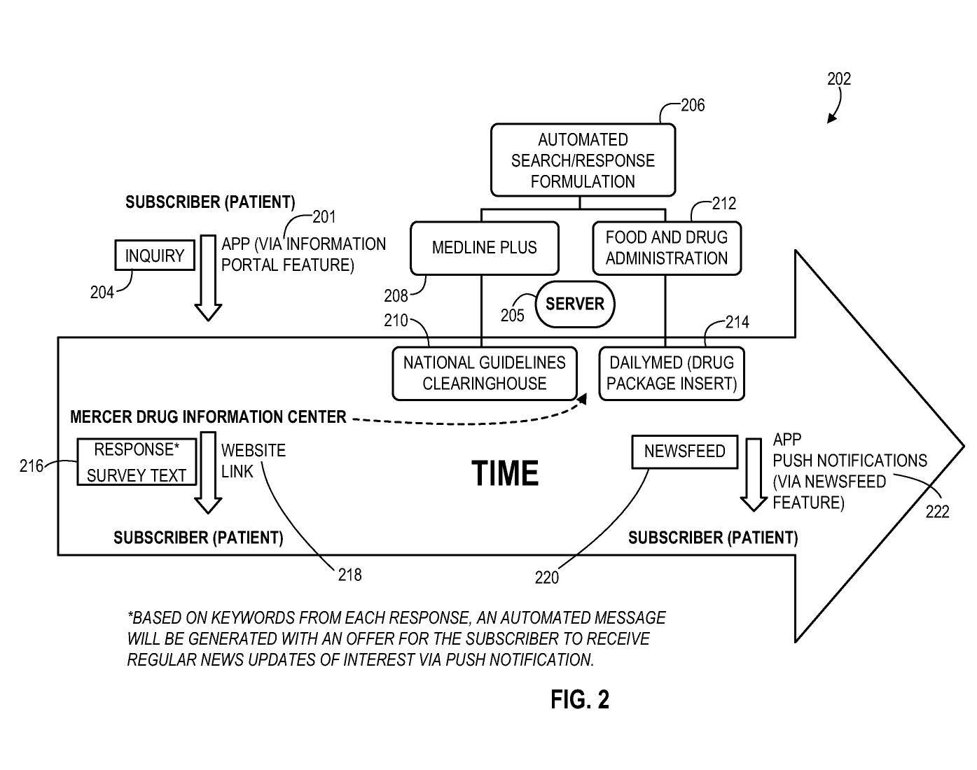

FIG. 2 shows an example of another process 202 for receiving a drug related electronic inquiry 204 from a requester such as a patient as well as formulating and delivering a response 216. In this particular example, the requester utilizes an application program 201 that provides an information portal or accesses a web based information portal. As in process 102 of FIG. 1, the information portal provides a user interface for submitting the electronic inquiry 204. This user interface is also discussed in more detail below with reference to FIG. 6.

The inquiry 204 requests information about a particular drug, and the inquiry 204 is then handled based on various factors. For instance, in this example of the process 202, the response 216 is intended to be standardized and provide information suitable for a patient that limits exposure to liability. Therefore, the inquiry 204 is handled directly by a server 205 of the health information center that implements the process 202, which may also be the same server discussed above in relation to FIG. 1. The server 205 performs a search and formulation 206, which involves researching within publicly available resources that are intended for the general public, including databases of Medline Plus 208, the National Guidelines Clearinghouse 210, the FDA 212, and the Daily Med drug package inserts 214. According to some implementations, the server 205 is restricted to only those four particular databases: Medline Plus 208, the National Guidelines Clearinghouse 210, the FDA 212, and the Daily Med drug package inserts 214. The server 205 may also employ a drug interaction checker resource such as the interaction tool found at http://rxnav.nlm.nih.gov/NdfrtAPIs.html#.

After the search 106 of these resources intended for the general public commences, the server then begins completing the search and formulation process 206 by creating the standardized response. Here, the links, blurbs, paragraphs, or even entire documents are compiled into the response format intended for the patient. The standard formulated response is accessed by the server 205 and then delivered to the requester.

The delivery of the formulated response may also be subject to various factors in this process 202. For instance, as with the process 102 of FIG. 1, the process 202 of FIG. 2 may allow for the requester to specify one or more delivery characteristics such as the type of delivery and/or the timeframe for delivery. In the example shown, the type of delivery has been established either by default, by preference, or by constraint imposed by the process 202 as being via a web link 218 that the requester can select. Manners of specifying such delivery characteristics as delivery type or timeframe are discussed in more detail below with reference to FIGS. 4A-6.

As with the process 102 of FIG. 1, the process 202 may also provide for ongoing updates regarding the subject matter of the inquiry 204 via newsfeeds 220 and notifications 222. The requester may be given an option, either at the time of receiving the response and/or at the time of establishing an account with the health information center, of subscribing to newsfeeds 220. The newsfeeds 220 may be based on keywords and/or categories found within the response. In this manner, the requester may receive current information relevant to the initial inquiry without subsequent inquiry submissions. According to some implementations, the newsfeeds 220 are restricted to only those from four particular databases: Medline Plus 208, the National Guidelines Clearinghouse 210, the FDA 212, and the Daily Med drug package inserts 214.

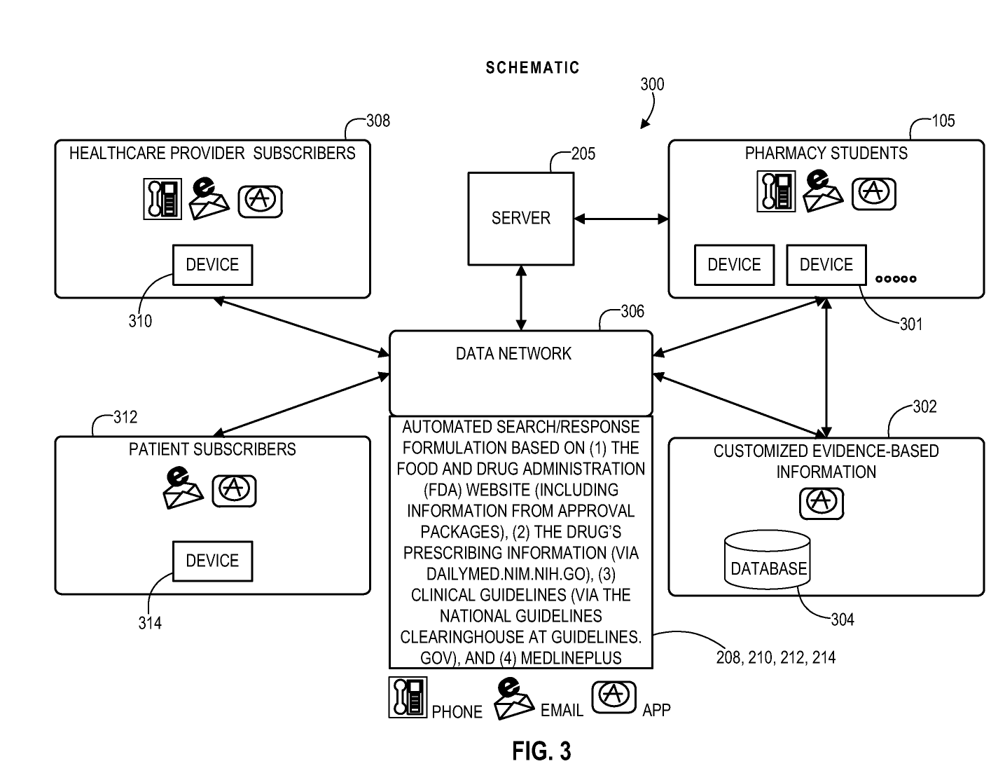

FIG. 3 shows an example of a system 300 of the health information center that may provide processes such as the process 102 of FIG. 1 and/or the process 202 of FIG. 2. FIG. 3 further illustrates the interconnectedness of the system of the health information center to the requesters and the resources used to formulate the responses. The system 300 includes one or more server computers 205 that are linked to one or more computer devices 301 in use by the students 105 or other researches of the health information center. The server 205 and computer devices 301 may be linked through a local area data network and/or through a public data network 306 such as the Internet.

The pharmacy students 105 have access to the server 205, to the Internet or other public data network 306, as well as to a database 304 or other storage that maintains the customized, evidence based information that has been compiled for responses to inquiries. The pharmacy students 105 also have access through the public data network 306 and/or through local area networks of the health information center to resources, whether public or private in nature, that provide drug related research information that may be relied upon when formulating the customized responses.

The pharmacy students 105 or other researchers have access to electronic forms of communication such as email, dedicated application program communications, and the like for purposes of research and initiating delivery of the responses to the inquires. The pharmacy students 105 also have telephone access to audibly deliver responses to those requesters who may prefer phone calls.

The server 205 has access to publicly available resources 208-214 via the public data network 306. This allows the server 205 to perform the automated search of the publicly available resources 208-214 to formulate the standardized response that may be delivered to requesters such as patients. Furthermore, the server 205 utilizes the public data network 306 to deliver information to the requester, such as progress indicators, the formulated response to the inquiry, and the newsfeeds that have been requested.

The requesters may communicate with the system 300 in various ways. In this particular example, requesters who are healthcare providers 308 have devices 310 that are connected to the public data network 306 and offer email communications and/or application program communications with the server 205 including web based portals as previously mentioned. Device 310 may include personal computers, tablet computers, smartphones and the like. Furthermore, in some implementations the healthcare providers have access to telephones that may be used to as a readily available form of communication to contact representatives of the drug related information center, such as the pharmacy students 105 who are conducting the research and formulating the responses. Additionally, a telephone service may be provided by the health information center as a form of communication available to the healthcare provider 308 only during service outages that prevent other types of electronic communication

As another example, requesters who are patients 312 have devices 314 that are also connected to the public data network 306 and offer email communications and/or application program communications with the server 205 including web based portals. Device 314 may include personal computers, tablet computers, smartphones and the like. In this example, the patients are not offered the option of contacting the health information center via telephone or receiving responses to inquiries via telephone, so as to insulate the representatives of the health information center from the general public. However, in other examples, telephone access may be provided to patients as a readily available form of communication or as a form of communication available to the patient 312 only during service outages that prevent other types of electronic communication.

Returning to the system 300, the server 205 orchestrates the operation of the system 300, such as by providing the logic and functions to implement the processes 102, 202 of FIGS. 1 and 2. For example, the server 205 may implement the set 400 of operations shown in FIGS. 4A-C which merge the processes 102 and 202 to provide service to both healthcare providers and patients. As an alternative, the server 205 may implement only those operations needed to provide one of process 102 or process 202.

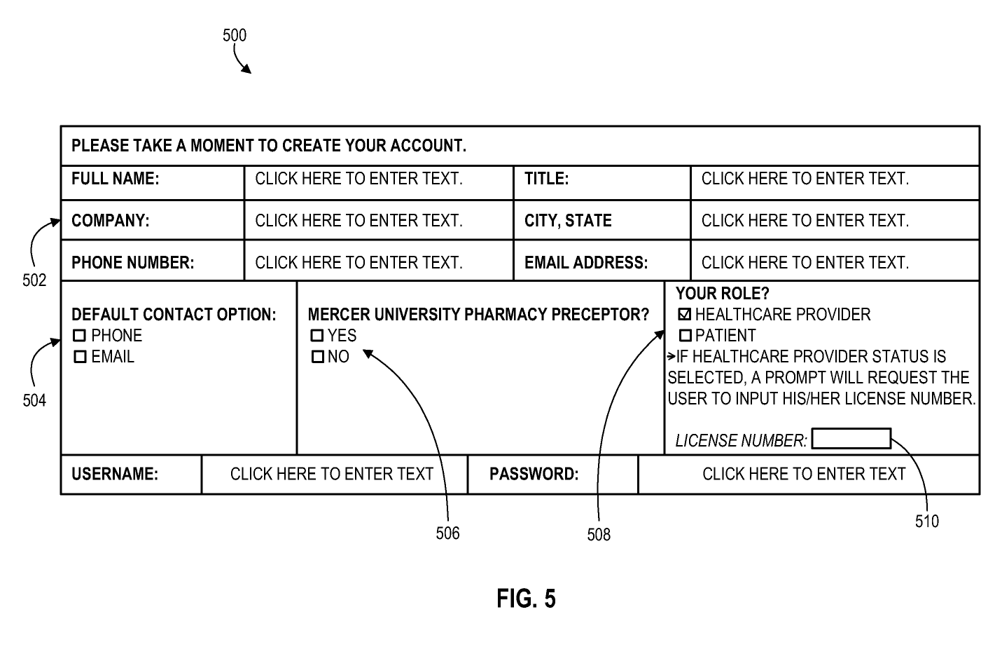

Initially, the requester accesses an interface of a dedicated application program for interacting with the server 205 or accesses a web based interface provided by the server 205 at an access operation 402. The server 205 then detects at a query operation 404 whether this is the first time this particular requester has accessed the site, such as by the requester either logging in manually or automatically to an existing account or by selecting an option to create an account.

Where account creation is necessary, the user then proceeds to create an account at an account operation 406. FIG. 5 shows an example screen capture 500 of a display 408 of FIG. 4A that is shown to the requester during account creation. The display 408 provides various user inputs, such as the typical name and contact section 502, but additional information as well. For instance, the display 408 may provide an input 504 for the default type of delivery desired, such as email versus phone, and may also provide an input 508 for specifying the type of requester, such as healthcare provider versus patient. The display 408 may also provide an input 510 for a healthcare provider to enter a license number so that the server 205 may confirm the licensure of the healthcare provider before deciding to provide customized responses to inquiries from the healthcare provider.

Additionally, where the requester has selected the type as being a healthcare provider, the display 408 may provide an input 506 for receiving a selection of whether the healthcare provider is affiliated with a particular organization, such as being a preceptor for a university that provides the health information center. This information will be used when determining whether to allow access to the references cited in the customized response.

Once the requester submits the account creation information, the server 205 then detects whether the requester indicated the requester type as a healthcare provider at a query operation 410. Where the requester is specified as a patient, no further action is taken at skip operation 414 and then the operational flow proceeds to a home operation 418 where a home screen is displayed for requesters who are logged in. Where the requester is specified as a healthcare provider, then the server 205 then initiates a verification process of the licensure of the healthcare provider. This process may be an automated look-up of the specified license number or may be a manual task that is assigned by the server 205 to a health information center representative. Upon confirming the license, the healthcare provider is then directed to the home operation 418.

Returning to query operation 404, where the requester already has an account and a log in 416 has occurred, the subscriber then is provided a home page either by the dedicated application program or from the web based interface at the home operation 418. Here the subscriber is shown a display 420, an example being screen capture 600 shown in FIG. 6. This display 420 includes various subscriber inputs, including an inquiry portion 603 that can receive free text as well as a category portion 604, such as a drop down menu with pre-defined selections, where the requester can chose to categorize the inquiry to better ensure accuracy, particularly for automated searches for patients. The display 420 may further have an input 606 for receiving a timeframe for delivery of the response. One or more disclaimers 608, 610 may also be displayed at a disclaimer operation 422 as part of the original display or as a pop up upon entering the inquiry.

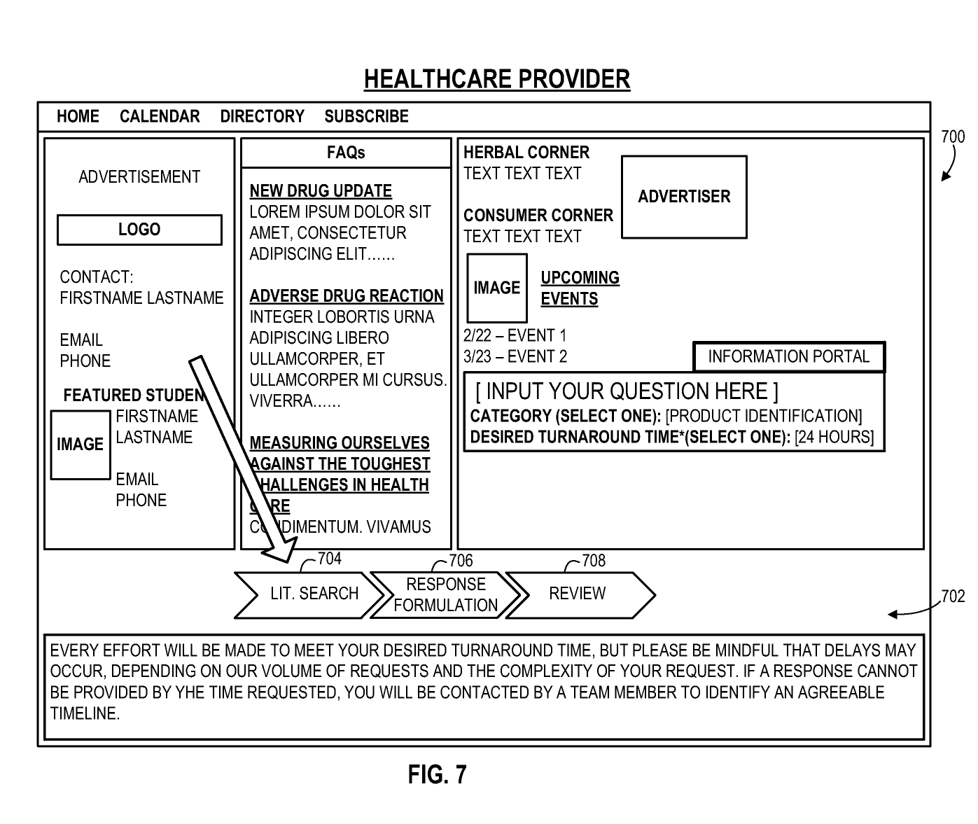

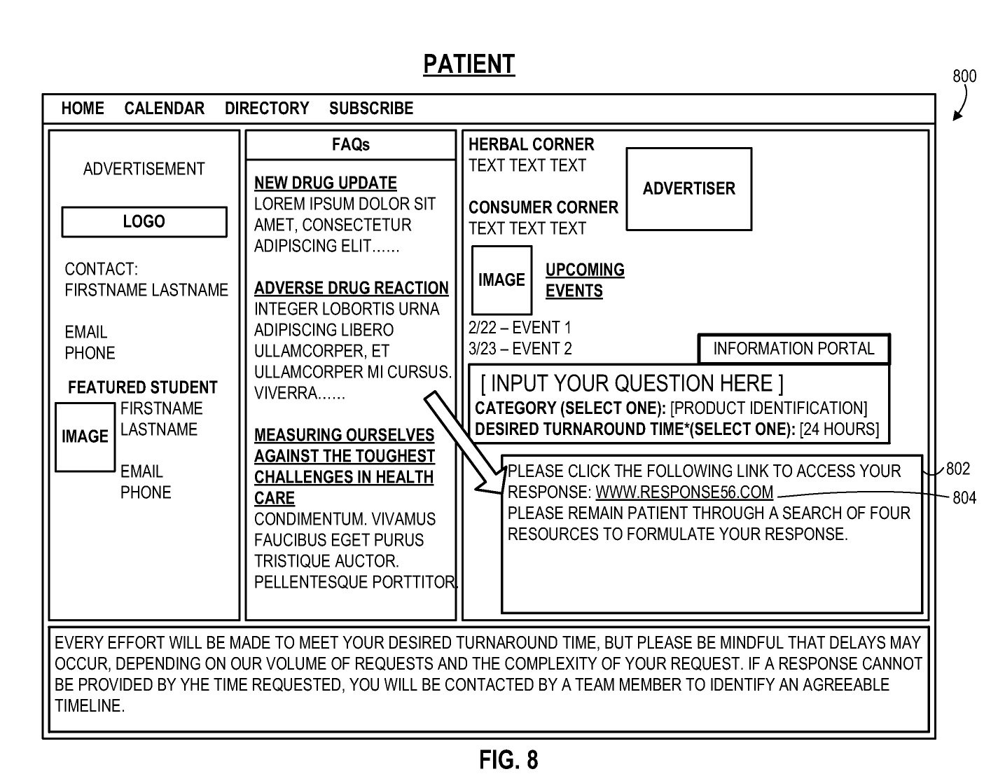

In this example, the subscriber submits the inquiry including entering the free form text to specify the question, a category, and a turn-around time at a submission operation 424. In this example, the server 205 then determines at query operation 426 whether to provide a display to the requester that is appropriate for a healthcare provider or appropriate for a patient. Where the requester is a healthcare provider, the server 205 then generates a display 428, a screen capture 700 of FIG. 7 being an example. The display 428 provides a progress indicator 702, which in this example includes three steps 704, 706, 708 with the current step being indicated. This gives the healthcare provider assurance that the process of responding to the inquiry is underway and is progressing on the expected time frame.

Where the requester is a patient, the server 205 then generates a display 430, a screen capture 800 of FIG. 8 being an example. The display 430 provides a section 802 where a response instruction is provided. In this example, the response instruction includes a link 804 that the patient may click to then be taken to a response page that continuously updates as the server 205 performs the automated searching of the publicly available information and the standardized response formulation.

Concurrently with providing the displays 428, 430, the server 205 also orchestrates the remainder of the response process. The server 205 delivers the inquiries to a pharmacy student 105 or other researcher via an email or through a dedicated application program at an inquiry operation 432. The selection of the student for delivery may occur in various ways, such as by random assignment, by round-robin assignment, by workload balancing, or to a dedicated gatekeeper person who then subsequently assigns the inquiry. In this example, the server 205 delivers all inquiries regardless of the requester type to the pharmacy student. This allows the pharmacy student or other gatekeeper to keep track of all inquiries and monitor their progress including those where the research and response are automated. In other examples, the inquiries from a patient may proceed directly to the automated activities while the inquiries from a healthcare provider proceed to a student or gatekeeper.

Again, the server 205 bases the operational flow on whether the requester is a patient or a healthcare provider at a query operation 434. For patients, the server 205 then performs the automated searching of the publicly available information and standardized response formulation at a response operation 436. The server 205 builds the response page as information is being discovered during the search. The automated searching occurs by extracting keywords from the inquiry and performing a look-up of those keywords. Filtering of the search findings may then be performed based on the category that has been specified in the response. In building the response page, in some embodiments the server 205 may proceed to deliver an option to the patient requester via the app or website to offer the patient the option to call the drug information center pursuant to the contact operation 437. This added level of interaction may be offered for a separate fee.

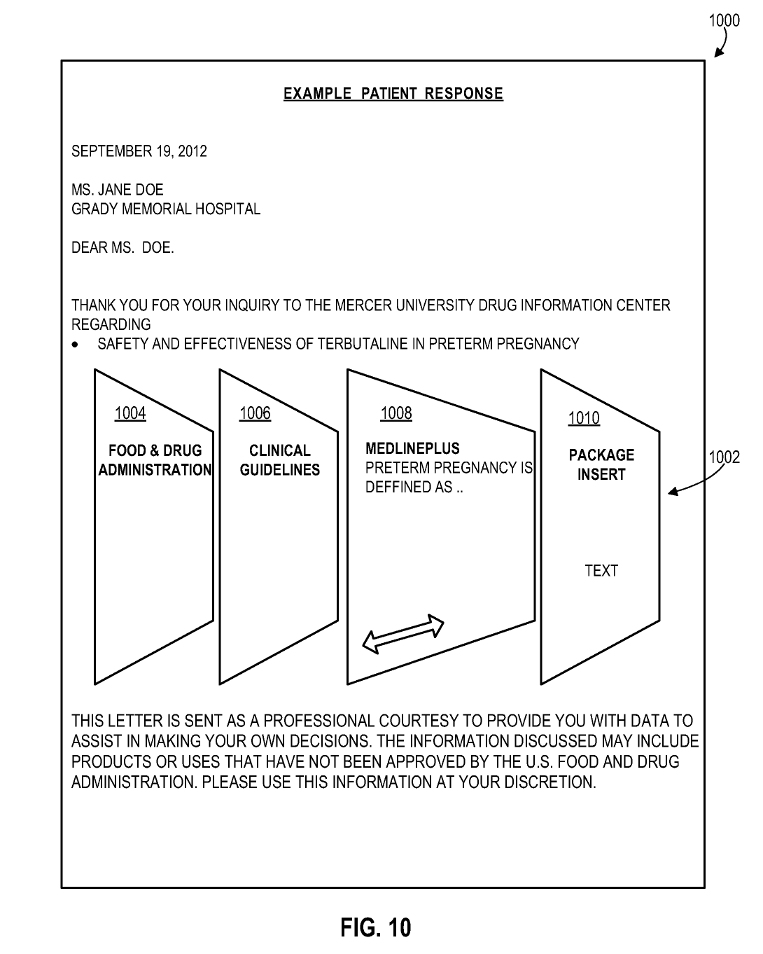

FIG. 10 shows an example of a screen capture 1000 that is shown to a patient upon the patient clicking the link 804 of FIG. 8. In this particular example, the four resources 208-214 from FIG. 2 are shown as a group 1002 of selectable objects 1004, 1006, 1008, and 1010 where each object is populated with information that has been discovered by the automated search. At the point in time shown in FIG. 10, the object 1010 representing the package insert resource has been populated while the other resources are currently in progress. The object 1008 has been selected by the patient which may expand the object 1008 for better viewing.

Concurrently with building the response display as shown in FIG. 10, the server may also send a survey to the patient, such as via a text message to a contact number or as an addition to the response display. The survey may gather information from the patient regarding their experience, including whether the question was adequately answered, a rating for the response, the amount of time it took to receive access to the response, and whether the response time met expectations. The survey may allow for a response to be submitted back to the server 206, and the health information center personnel may then review the survey responses to learn where system improvements are needed.

Returning to the query 434, for healthcare providers the server 205 has already distributed the inquiry to an appropriate pharmacy student or other researcher. Therefore, that student or other researcher begins the literature search, the response formulation, and peer review circulation at operation 438. The server 205 monitors the progress by having the student input information to identify the stage of the process, and the server 205 utilizes that input information to then generate the progress indication 702 of FIG. 7 that the healthcare provider can view at any time during the process. In addition to monitoring for purposes of providing progress indicators, the server 205 may also provide the students 105 or other researchers with periodic updates on the timeframe and the amount of time remaining to deliver the response, as specified by the requester. In this manner, the student 105 or other researcher may properly prioritize the inquiry in relation to other assigned inquiries and may maintain progress at an appropriate pace to meet or exceed the specified timeframe. According to some embodiments, the server 205 may also provide the automated search of operation 436 as an option to further supplement the result being provided to the healthcare provider.

Upon finalization of the response formulation, the server 205 then performs concurrent operations to deliver the response. For the healthcare provider, the account information specifies whether there is an affiliation with an organization that allows copies of resources cited within the response to be provided. The health information personnel have verified that status where such verification is appropriate. For instance, the healthcare provider may be a preceptor for the university that provides the health information center. The server 205 detects from the account information whether the healthcare provider has the appropriate affiliation at a query operation 440. Where the affiliation exists, the server 205 then appends the resources that have been cited at a reference operation 442, or omits the references at a reference operation 444. One manner of doing so involves the researcher flagging the resources or saving copies of the resources to the response database in association with the response. The server 205 may then find and append the resources to the response document that has been generated prior to delivery of the response, or may deliver the cited documents as a separate delivery.

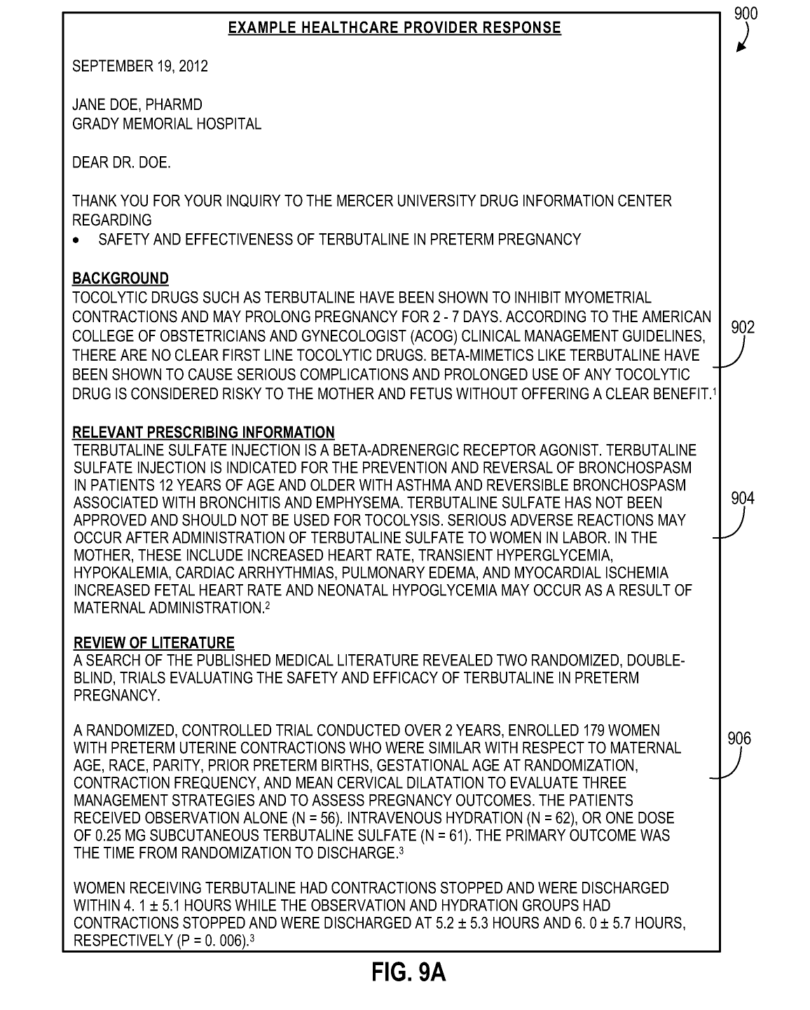

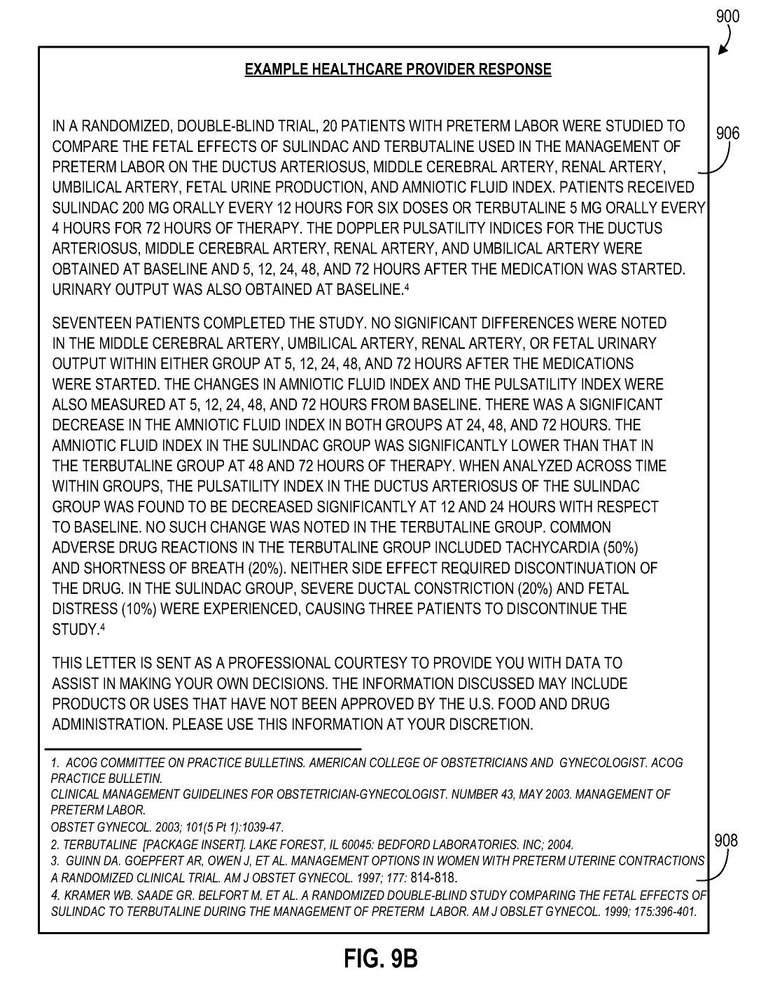

Concurrently, the server 205 detects from the account information whether the default contact option is for email, phone, or other form of electronic delivery such as via a dedicated application program at a query operation 446. Where the delivery option is specified as a phone, the pharmacy student then makes the phone call to report the response. At a response operation 450, the server 205 may prompt the pharmacy student to provide the response via phone upon the pharmacy student indicating the status of the response as being finalized. The server 205 may also send a survey as described above via a text or other electronic communication at this point.

Where the delivery option is specified as email or other electronic delivery such as via the dedicated application program or web portal, the server 205 disseminates the response document accordingly at a response operation 448. The server 205 may also send a survey as described above via a text or other electronic communication at this point. An example of the finalized response document showing the customized response content 900 is shown in FIGS. 9A and 9B. In this particular example, the customized response contains a background section 902, prescribing information section 904, literature review section 906, and a references list 908. The customized response content 900 of this example may provide a comprehensive view of all of the published primary literature that has been deemed relevant to the inquiry where this comprehensive view is tailored to the specific inquiry that has been provided by the requester. Copies of those references in the list 908 may be provided to the requester where the appropriate affiliation exists, as discussed above in relation to query 440.

In conjunction with delivering the response, the server 205 may also generate an electronic message, such as an email, a text message, or dedicated application based communication to offer the requester a newsfeed related to the response to the inquiry at a newsfeed operation 452. The server 205 may extract keywords from the response, for instance, by finding keywords flagged or otherwise specified by the student or other researcher who drafted the response. The electronic message may provide for the requester responding to the offer with a return electronic message that is received by the server 205. The server 205 detects whether the offer has been accepted at a query operation 454. If no response or a negative response has occurred, then the server 205 takes no further action within respect to the inquiry at a skip operation 456. Where the server 205 does receive an acceptance of the offer, then server 205 then begins pushing electronic notifications of the newsfeed to the requester at a notification operation 458.

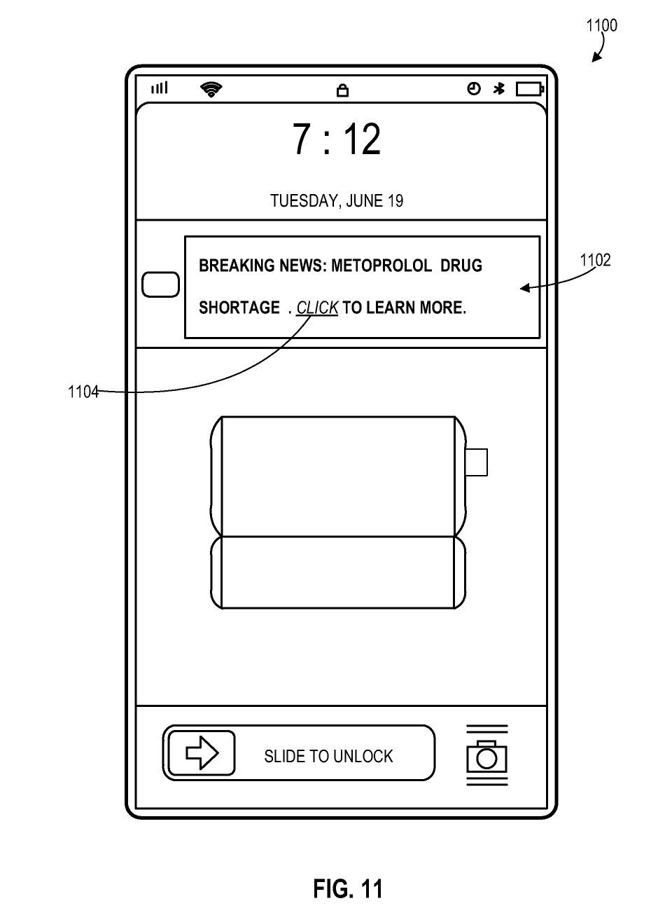

FIG. 11 shows an example 1100 of a screen capture of an electronic notification received by a device of the requester. A notification message 1102 displays on the device to inform the requester of the current newsfeed. The notification message 1102 includes a link 1104 that the requester may click to then access the newsfeed and review the current information related to the inquiry previously submitted.

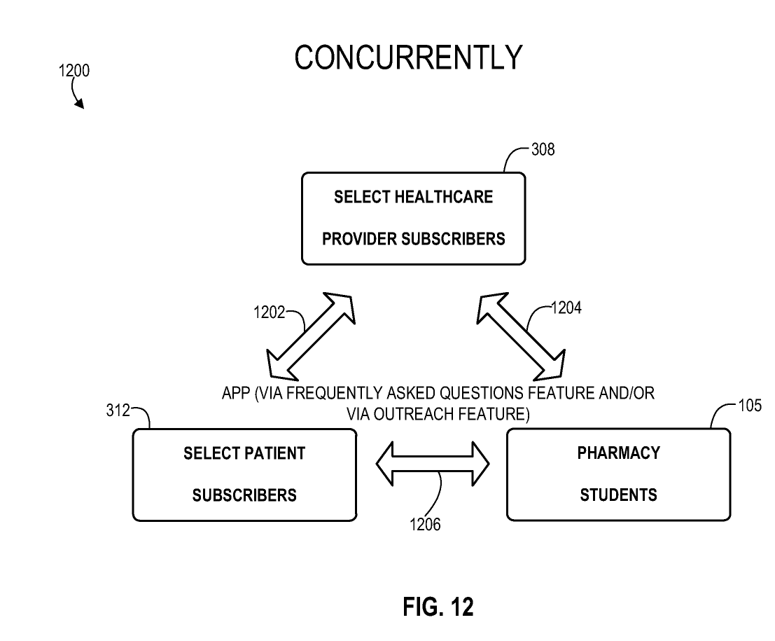

In addition to the system 300 of FIG. 3 providing the processes 102 and 202 of FIGS. 1 and 2 via the server operations 400 of FIGS. 4A-C, the system 300 may further provide an online community via community operation 460 of FIG. 4A. An example 1200 of an online community to promote interaction between the patients 312, healthcare providers 308, and pharmacy students 105 and other health information center personnel as shown in FIG. 12. The online community 1200 may be open to all requesters and/or may establish dedicated interconnections 1202, 1204, and 1206 between the respective parties involved. This online community 1200 may allow for some number of the most frequently asked questions and the corresponding responses to be posted and allow for comments from appropriate parties. One set of frequently asked questions and related answers may be provided for healthcare providers while a separate set may be provided for patients. This online community information can be accessed from the home page discussed above with respect to FIGS. 4 and 6. Likewise, this online community 1200 may allow for an outreach program whereby users can post user profiles, resumes, job openings, and the like. Furthermore, the online community 1200 may offer customized continuing education opportunities including those that may be offered by third parties and the application or website may direct requesters to those opportunities in response to keywords of the requests.

The system 300 of the health information center may utilize various business models to produce revenue if desired. For example, advertisement space on home screens such as the example 600 in FIG. 6 may be sold to advertisers. Furthermore, requesters may be provided service on a subscription basis. The subscription may be a fee charged at regular intervals regardless of usage amount or may be usage based fees. Furthermore, where the system 300 is accessed via dedicated application programs running on the requesters devices 310, 314, a copy of the application program with an associated license for use may be sold to the requesters through an application store.

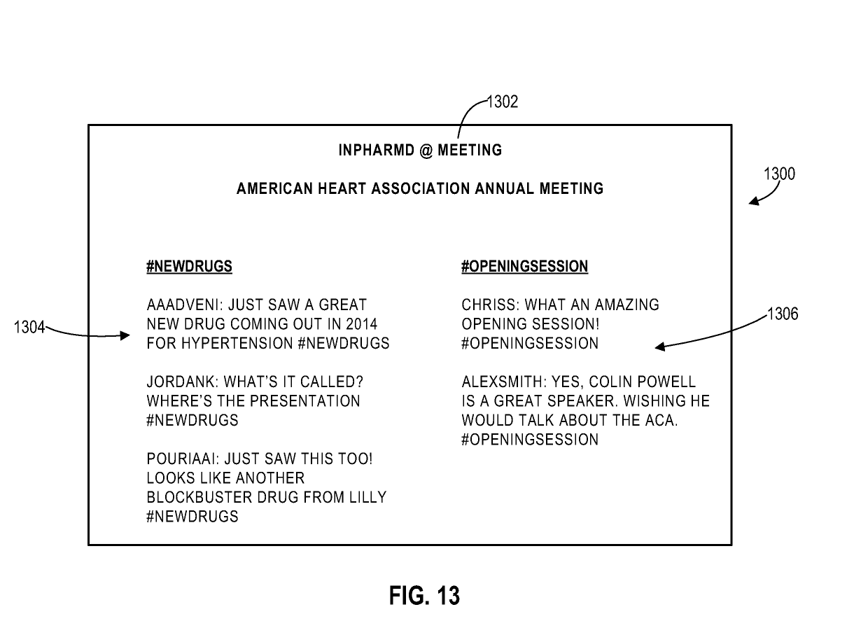

Various embodiments may also provide social networking features to further connect requesters of drug related information. Users may post messages to various forums that are maintained by the server 205. Users may be provided the option to post messages, and techniques such as hashtagging may be employed to allow posters to develop threads of related posts. Furthermore, users can use conventions such as @<name> to flag another user within a post in order to direct that post to the other use. As shown in the screen capture 1300 of FIG. 13, the server 205 has displayed via the dedicated application or through a web browser a collection of threads 1304, 1306 organized by hashtag. These threads have been posted to a meeting forum 1302, and specifically to an American Heart Association Annual Meeting within the meeting forum 1302. There may be many forums where messages may be posted, including forums for patients, health providers, or both.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of providing health related information, comprising:
receiving an electronic inquiry for health related information;
receiving an entry of an electronic response delivery characteristic;
formulating a customized electronic response to the electronic inquiry, the customized electronic response providing the health related information; and
providing the customized electronic response to the electronic inquiry in accordance with the electronic response delivery characteristic.

2. The method of claim 1, wherein the electronic response delivery characteristic comprises a delivery format.

3. The method of claim 1, wherein the electronic response delivery characteristic comprises a delivery time frame.

4. The method of claim 1, further comprising determining from the inquiry whether a requester is a healthcare provider or a patient, and when the requester is a healthcare provider then formulating the customized electronic response.

5. The method of claim 4, further comprising determining from the inquiry whether the healthcare provider has affiliation to a particular organization, and when the healthcare provider does have affiliation to the particular organization, then including access to electronic resources used when formulating the customized electronic response from the customized electronic response.

6. The method of claim 4, wherein when the requester is a patient, the method further comprises performing an automated electronic search of an electronic resource and returning an electronic response that includes health related information in accordance with the electronic response delivery characteristic.

7. The method of claim 1, further comprising determining from the inquiry whether the requester has an affiliation to a particular organization, and when the requester does have the affiliation to the particular organization, then including access to electronic resources used when formulating the customized electronic response from the customized electronic response.

8. The method of claim 1, further comprising providing electronically an indicator of a stage of completion of responding to the electronic inquiry.

9. The method of claim 1, wherein formulating the customized electronic response comprises performing a literature search and including information discovered from the literature search within the customized electronic response.

10. The method of claim 1, further comprising establishing an account for the requester, the account storing preferences for a default electronic response delivery method and for subscription to newsfeeds related to the electronic inquiry.

11. A method of providing health related information, comprising:
receiving an electronic inquiry for health related information;
determining from the inquiry whether a requester is a healthcare provider or a patient;
formulating an electronic response to the electronic inquiry with the health information of the electronic response being based on whether the requester is a healthcare provider or a patient; and
providing the electronic response to the electronic inquiry.

12. The method of claim 11, wherein when the requester is a healthcare provider, the method further comprising determining from the inquiry whether the healthcare provider has an affiliation to a particular organization, and when the healthcare provider does have the affiliation to the particular organization, then including access to electronic resources used when formulating the electronic response from the electronic response.

13. The method of claim 11, wherein when the requester is a patient, the method further comprises performing an automated electronic search of an electronic publicly available resource and returning an electronic response that includes health related information from the automated search.

14. The method of claim 11, further comprising determining from the inquiry a timetable for providing the health related information, and wherein providing the customized electronic response occurs within the timetable.

15. The method of claim 11, further comprising providing electronically an indicator of a stage of completion of responding to the electronic inquiry.

16. The method of 11, further comprising establishing an account for the requester, the account storing preferences for a default electronic response delivery method and for subscription to newsfeeds related to the electronic inquiry.

17. The method of claim 11, wherein when the requester is a healthcare provider, then formulating the customized electronic response comprises performing a literature search and including information discovered from the literature search within the customized electronic response.

18. A computer system, comprising:
a network interface; and
a processor in communication with the network interface, the processor being configured to:
receiving an electronic inquiry for health related information;
receiving an entry of an electronic response delivery characteristic;
determining from the inquiry whether a requester is a healthcare provider or a patient;
accessing an electronic response to the electronic inquiry with the health information of the electronic response being based on whether the requester is a healthcare provider or a patient; and
providing the electronic response to the electronic inquiry in accordance with the electronic response delivery characteristic.

19. The computer system of claim 18, further comprising a storage device that stores account information including an identification of the requester, the processor being in communication with the storage device, the processor being configured to determine from the inquiry whether a requester is a healthcare provider by receiving account credentials from the requester and performing a look-up of the account credentials within the account information of the storage device to find the identification of the requester.

20. The computer system of claim 19, wherein the account information for a requester who is a healthcare provider further includes whether the healthcare provider has an affiliation to a particular organization, and wherein the processor is further configured to determine whether the healthcare provider has the affiliation and includes access to references used to formulate the electronic response when providing the electronic response for healthcare providers who have the affiliation.
